(19) United States
(12) Patent Application Publication
(10) Pub. No.: US 2025/0154029 A1
(43) Pub. Date: May 15, 2025

(54) Installation for treating excrement comprising urine and fecal matter

(71) Applicant: ETTELIOT, NANTES (FR)

(72) Inventors: Alexandre EVRARD, NANTES (FR); Gustav SIEVERS, GREIFSWALD (DE)

(21) Appl. No.: 18/839,403

(22) PCT Filed: Feb. 16, 2023
(86) PCT No.: PCT/FR2023/050220

§ 371 Date: Aug. 16, 2024

(30) Foreign Application Priority Data
Feb. 17, 2022 (FR) FR2201389
Feb. 17, 2022 (FR) FR2201391

(51) Int. Cl. C02F 1/461; C02F 11/06; C02F 103/00

(52) U.S. Cl. CPC C02F 1/46104; C02F 11/06; C02F 2103/005; C02F 2201/009; C02F 2201/46115

(57) ABSTRACT

An installation is provided (1) for treating excrement comprising a urine treatment unit (3) and a fecal matter combustion station (5) The urine treatment unit (3) has a station (4) for converting urine into dihydrogen, and the fecal matter combustion station (5) has, housed inside a combustion chamber (6), a dihydrogen-powered burner (7). The treatment installation (1) has a fluidic connection (8) between the station (4) for converting urine into dihydrogen and the fecal matter combustion station (5) so as to allow the burner (7) to be supplied with dihydrogen from the dihydrogen produced at the station (4) for converting urine into dihydrogen. The installation has an excrement collection station (2) with a urine collecting part (2A) connected to the inlets (41) of the station (4) for converting urine into dihydrogen by a fluid circulation circuit (9), and a separate fecal matter collecting part (2B) connected to the combustion chamber (6) without the connection passing through the urine treatment unit (3).

The present invention relates to an installation for treating excrement comprising urine and fecal matter.

It relates in particular to an installation for treating excrement comprising urine and fecal matter, said treatment installation, which may in certain cases also be called lavatory, comprising a urine treatment unit and a fecal matter combustion station, the urine treatment unit comprising at least one station for converting urine into dihydrogen, the fecal matter combustion station comprising, housed inside a combustion chamber, at least one dihydrogen-powered burner and the treatment installation comprising at least one fluidic connection between the or at least one of the stations for converting urine into dihydrogen and the fecal matter combustion station so as to allow the burner to be supplied with dihydrogen from the dihydrogen produced at the station for converting urine into dihydrogen.

Numerous excrement treatment installations have to, as a result, for example, of their location, allow treatment in situ, i.e. at or near the micturition and defecation zone. Such treatment installations thus also form the sanitary apparatus for micturition and defecation and are therefore called toilets. However, the excrement treatment installations developed to date, whether or not they incorporate a micturition and defecation zone, are bulky, require frequent maintenance, in particular in terms of emptying the installation, and are very energy intensive. This is the case for the installation described in document U.S. Pat. No. 4,045,314, which proposes an evaporation of the urine that is very energy intensive. Furthermore, such an installation is, as a result of its design, very bulky and the treatment time is very long.

The aim of the present invention is therefore to propose an excrement treatment installation of the abovementioned type, the design of which makes it possible to produce a compact, low-maintenance installation that is optimized in terms of energy consumption.

To this end, one subject of the invention is an installation for treating excrement comprising urine and fecal matter, said treatment installation comprising a urine treatment unit and a fecal matter combustion station, the urine treatment unit comprising at least one station for converting urine into dihydrogen, the fecal matter combustion station comprising, housed inside a combustion chamber, at least one dihydrogen-powered burner and the treatment installation comprising at least one fluidic connection between the or at least one of the stations for converting urine into dihydrogen and the fecal matter combustion station so as to allow the burner to be supplied with dihydrogen from the dihydrogen produced at the station for converting urine into dihydrogen, characterized in that the installation comprises an excrement collection station with a urine collecting part and a fecal matter collecting part that are separate, for dissociated collection of urine and fecal matter, in that the station for converting urine into dihydrogen has at least one liquid inlet and one outlet for gaseous fluid in the form of dihydrogen, in that the urine collecting part of the excrement collection station is connected to the or one of the inlets of the station for converting urine into dihydrogen by a fluid circulation circuit, and in that the fecal matter collecting part of the excrement collection station and the combustion chamber of the fecal matter combustion station that comprises a fecal matter supply inlet are connected to one another without passing through the urine treatment unit.

The designs of the urine treatment unit and of the combustion station make it possible to use the dihydrogen produced at the urine treatment unit for the operation of the combustion station. This results in lower energy consumption. By virtue of the fact that the urine collecting part of the excrement collection station is separate from the fecal matter collecting part, and that the station for converting urine into hydrogen is supplied exclusively by the urine collecting part while the combustion chamber is supplied directly by the fecal matter collecting part, i.e. without the fecal matter passing through the urine treatment unit, this results in a smaller volume of product to be treated and a shorter treatment time without impairing the effectiveness of the treatment.

According to one embodiment of the invention, the fluid circulation circuit connecting the urine collecting part of the excrement collection station to the or one of the inlets of the station for converting urine into dihydrogen comprises at least one electrolyzer disposed on said circuit, this electrolyzer comprising at least one liquid inlet connected to the urine collecting part of the collection station and at least one liquid outlet connected at least by said fluid circulation circuit to the or an inlet of the station for converting urine into dihydrogen.

The presence of an electrolyzer interposed between the urine collecting part of the excrement collection station and the inlet of the station for converting urine into dihydrogen makes it possible to pretreat the urine, in particular to subject it to oxidation before introducing the urine into the station for converting urine into dihydrogen. The urine is said to be converted into gray water.

According to one embodiment of the invention, the fluid circulation circuit comprises, between the urine collecting part of the excrement collection station and the liquid inlet of the electrolyzer, a reservoir with a buffer reservoir function for allowing operation referred to as “batch” operation of the electrolyzer. This arrangement makes it possible to ensure the effectiveness of the treatment of urine at the electrolyzer.

According to one embodiment of the invention, the fluid circulation circuit comprises, between the electrolyzer and the inlet of the station for converting urine into dihydrogen, a branch on which is disposed an ultrasound generator, the point at which the circuit divides to form said branch being called point of origin of said branch. The presence of an ultrasound generator makes it possible to convert at least a part of the urine from the electrolyzer into a cloud of particles in the form of mist and to discharge it into the atmosphere. This results in the disappearance of a large part of the urine without having to empty the installation.

According to one embodiment of the invention, the ultrasound generator comprises a chamber and an apparatus for ultrasound nebulization housed inside said chamber, said chamber is equipped at least with a forced fluid circulation device, with at least one outlet to the ambient air and with at least one liquid inlet in fluidic communication with the or at least one of the liquid outlets of the electrolyzer for supply of said chamber with electrolyzed liquid urine, said nebulization apparatus is configured to convert at least a part of the electrolyzed liquid urine from the electrolyzer into a cloud of fine particles of mist type, and the forced fluid circulation device is configured to guide movement of the mist produced in the direction of the or at least one of the outlets to the ambient air of said chamber.

According to one embodiment of the invention, the fluid circulation circuit comprises, at said point of origin of the branch, a connecting member, such as a three-way valve or a T-shaped connector, configured to allow, in parallel, supply of the branch and of the station for converting urine into dihydrogen with liquid from the electrolyzer. Thus, dihydrogen and a mist can be produced in parallel from the electrolyzed urine, from the electrolyzer. This allows a sufficient treatment duration at each level of the installation.

According to one embodiment of the invention, the fluid circulation circuit comprises, between the point of origin of the branch and the inlet of the station for converting urine into dihydrogen, at least one filtration device. The presence of a filtration device makes it possible to improve the quality of the electrolyzed urine entering the station for converting urine into dihydrogen.

According to one embodiment of the invention, the combustion chamber of the fecal matter combustion station comprises at least one ash tray. This ash tray is preferably a removable tray so as to make the emptying thereof easier.

According to one embodiment of the invention, the installation comprises a cleaning product reservoir. The presence of a cleaning product reservoir makes it possible to clean the entire installation.

According to one embodiment of the invention, the station for converting urine into dihydrogen is an electrolyzer with a membrane. Such an electrolyzer with a membrane, as apparatus for producing dihydrogen and dioxygen, in particular by electrolysis of water, is well known to those skilled in the art and offers an output that is particularly advantageous for the treatment of water-rich urine.

A further subject of the invention is a method for treating excrement comprising urine and fecal matter by means of an excrement treatment installation comprising at least one burner, the method comprising a urine treatment step comprising at least one operation of converting at least a part of the urine into dihydrogen and a step of combustion of fecal matter with the aid of the dihydrogen-powered burner supplied with dihydrogen at least from dihydrogen produced from at least a part of the urine, characterized in that, the excrement treatment installation being of the abovementioned type and comprising at least one urine treatment unit and one fecal matter combustion station, the urine treatment unit comprising at least one station for converting urine into dihydrogen, the fecal matter combustion station comprising, housed inside a combustion chamber, the dihydrogen-powered burner, the method comprises a step of dissociated collection of urine and fecal matter so as to supply urine to the station for converting urine into dihydrogen of the urine treatment unit and to supply fecal matter to the combustion chamber without passing through the urine treatment unit.

### BRIEF DESCRIPTION OF THE DRAWINGS

The invention will be clearly understood upon reading the following description of exemplary embodiments, with reference to the appended drawings in which:

FIG. 1 shows a partial schematic view of an excrement treatment installation in accordance with the invention;

FIG. 2 shows a partial schematic view of a station for converting at least a part of the urine into dihydrogen of an excrement treatment installation in accordance with the invention;

FIG. 3 shows a partial schematic view of a fecal matter combustion station of an excrement treatment installation in accordance with the invention;

FIG. 4 shows a partial schematic view of an electrolyzer of an excrement treatment installation in accordance with the invention;

FIG. 5 shows a partial schematic view of an ultrasound generator of an excrement treatment installation in accordance with the invention.

As mentioned above, the excrement treatment installation 1 that is the subject of the invention is an installation that makes it possible to treat the excrement as close as possible to the place of micturition and defecation.

Such an installation 1 makes it possible to centralize the collection and the treatment.

Such an installation 1 is said to be autonomous.

Such an installation 1 may be a portable installation.

The treatment installation 1 comprises an excrement collection station 2 configured for dissociated collection of urine and fecal matter.

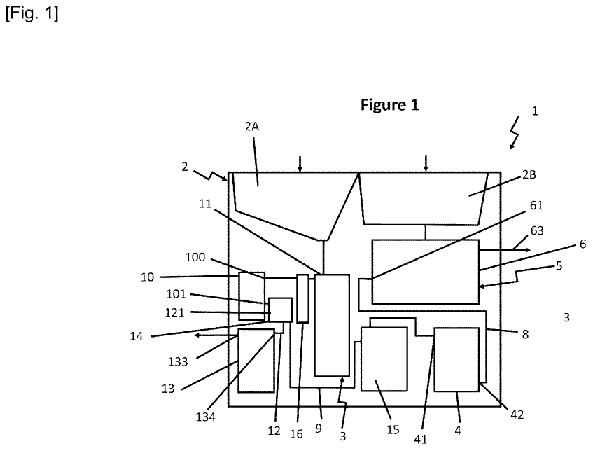

This excrement collection station therefore comprises a urine collecting part 2A and a fecal matter collecting part 2B. Said collecting parts are each in the form of a receptacle. Said receptacles may adjoin one another as illustrated in FIG. 1, so as to form either the equivalent of a toilet bowl at which the dissociation of the excrement into fecal matter and urine takes place automatically in view of the geometry and the arrangement retained for said receptacles, or receptacles that can be directly connected to the toilet bowl, when the toilet bowl is not incorporated in the excrement treatment installation 1.

The excrement treatment installation 1 further comprises a urine treatment unit 3 and a fecal matter combustion station 5.

The excrement collection station 2, the urine treatment unit 3 and the fecal matter combustion station 5 can be housed inside one and the same enclosure so as to form a compact and possibly portable assembly. At least a part of the urine treatment unit 3 may extend vertically in line with and beneath the urine collecting part 2A of the collection station 2 while at least a part of the fecal matter combustion station 5 may extend beneath and vertically in line with the fecal matter collecting part 2B of the collection station 2.

The urine treatment unit 3 is connected at the inlet to the urine collecting part 2A of the collection station 2 so as to be supplied with urine.

This urine treatment unit 3 comprises at least one station 4 for converting urine into dihydrogen.

This station 4 for converting urine into dihydrogen is an electrolytic station configured to convert urine into dihydrogen.

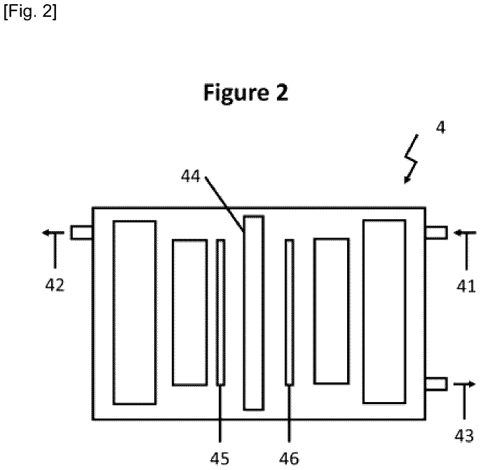

In the example shown in FIG. 2, the station 4 for converting urine into dihydrogen is an electrolyzer with a membrane 44. This electrolyzer with a membrane 44 may be an electrolyzer with a membrane that is commercially available. This electrolyzer with a membrane 44 known per se, conventionally used for electrolysis of water into dihydrogen and dioxygen, comprises an enclosure housing a membrane 44. This membrane 44 separates the enclosure of the electrolyzer with a membrane 44 into two chambers, one of which is equipped with a cathode shown at 45 in FIG. 2 and the other with an anode shown at 46 in FIG. 2.

The station 4 for converting urine into dihydrogen further comprises a liquid inlet shown at 41 in FIG. 2, an outlet for gaseous fluid in the form of dihydrogen shown at 42 in FIG. 2 and an outlet for gaseous fluid in the form of dioxygen shown at 43 in FIG. 2. The inlet and the outlets are formed by openings provided at the enclosure of the electrolyzer with a membrane 44.

In the examples shown, a single liquid inlet 41 is provided at the electrolyzer with a membrane 44, even if the latter may have a plurality thereof without departing from the scope of the invention.

The inlet 41 of the station for converting urine into dihydrogen is supplied with liquid by the urine collecting part 2A via a fluid circulation circuit 9, details of which will be provided below.

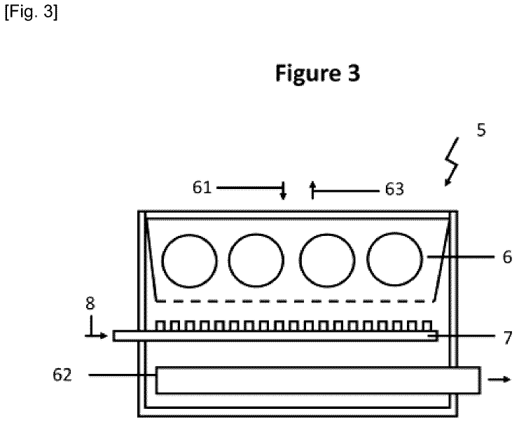

The fecal matter combustion station 5 for its part comprises, as illustrated in FIG. 3, a combustion chamber 6 housing a dihydrogen burner 7 for combustion of fecal matter and conversion into ash.

The combustion chamber 6 of the fecal matter combustion station 5 comprises a fecal matter supply inlet 61 connected to the fecal matter collecting part 2B of the excrement collection station 2 and at least one ash tray 62. The fecal matter collecting part 2B is connected directly to the fecal matter supply inlet 61 of the combustion chamber 6 without the fecal matter collecting part/combustion chamber connection passing through the urine treatment unit 3. This results in a small quantity of products to be burned in the combustion chamber.

The combustion chamber 6 comprises an outlet 63 for evacuating smoke resulting from the combustion.

The ash tray 62 is preferably disposed beneath the dihydrogen burner 7 that is in the form of a rail inside the combustion chamber 6.

In order to allow the burner 7 to be supplied with dihydrogen, the treatment installation 1 comprises at least one fluidic connection 8 between the station 4 for converting urine into dihydrogen and the fecal matter combustion station 5 so as to allow the burner 7 to be supplied with dihydrogen from dihydrogen produced at the station 4 for converting urine into dihydrogen.

Thus, the dihydrogen burner 7 is supplied with dihydrogen from the dihydrogen produced at the station 4 for converting urine into dihydrogen. This results in a reduced need for external energy.

In the example shown, the burner 7 is in the form of a rail delimiting a cavity. This rail is connected at one end by a fluidic connection 8 in the form of a gas pipe to the outlet 42 for gaseous fluid in the form of dihydrogen of the station for converting urine into dihydrogen. The dihydrogen produced is thus immediately used to reduce the amount of excrement to be stored.

The fluid circulation circuit 9 via which the urine collecting part 2A of the excrement collection station 2 is connected to the inlet 41 of the station 4 for converting urine into dihydrogen comprises an electrolyzer 10 disposed on said circuit 9. This electrolyzer 10 comprises at least one liquid inlet 100 connected to the urine collecting part 2A of the collection station and at least one liquid outlet 101 connected at least by said fluid circulation circuit 9 to the or an inlet 41 of the station 4 for converting urine into dihydrogen.

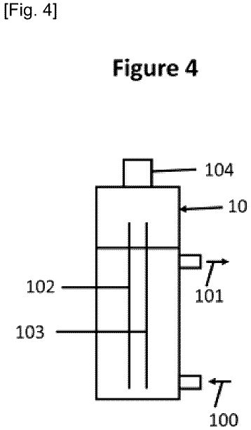

The detail of such an electrolyzer 10 is shown in FIG. 4. This electrolyzer 10 has no membrane. Ideally, the fluid circulation circuit 9 comprises, between the urine collecting part 2A of the excrement collection station and the liquid inlet 100 of the electrolyzer 10, a reservoir 11 with a buffer reservoir function for allowing operation referred to as “batch” operation of the electrolyzer 10.

Preferably, the electrolyzer 10 as shown in FIG. 4 comprises, between the liquid inlet 100 and the liquid outlet 101 via which the electrolyzed liquid is evacuated from the electrolyzer so as to supply, in particular, the station 4 for converting urine into dihydrogen, two electrodes, namely an anode 102 and a cathode 103, and an electrical power supply 104 that may be in the form of a battery operating on solar power or the like, such as wind power, connected to the electrolyzer.

The anode is preferably made of titanium and iridium and the cathode of graphite, carbon or stainless steel or else iron.

Generally, the electrolytic treatment is carried out with a voltage of between 2 and 12 volts, and the duration of the treatment can range up to 20 minutes for a unit volume of 250 ml. The treatment duration depends on the current and the potential selected.

Electrolytic treatment of the urine destroys all the enzymes, disinfects the urine, and oxidizes certain components of the urine into nitrate, struvite, or other degradation materials.

Generally, the capacity of the buffer reservoir is between 25 ml and 10 liters. In a variant, the electrolyzer 10 may be compartmentalized and comprise a first compartment housing the electrodes and equipped with the liquid outlet of the electrolyzer 10 and a second compartment that communicates with the first compartment, on the one hand by overflow and on the other hand via a pumping device. A level sensor is associated with the pumping device.

In practice, in order to obtain the required treatment effectiveness, a predetermined maximum amount of urine is introduced, via the connection between the buffer reservoir and the electrolyzer, into the electrolyzer 10. This connection between the buffer reservoir and the electrolyzer comprises at least one pump and one control unit of the pump.

At the end of a predetermined period of time, the electrolyzed urine is evacuated from the electrolyzer 10. Once this electrolyzed urine fraction has left the electrolyzer 10, a new urine fraction can be introduced from the buffer reservoir into the electrolyzer.

In the examples shown, not all of the electrolyzed urine from the electrolyzer is brought to the station 4 for converting urine into dihydrogen. Generally, around 10 to 20% of the amount of electrolyzed urine coming from the electrolyzer 10 is used for the production of dihydrogen. The rest is converted into mist so as to be evacuated into the atmosphere.

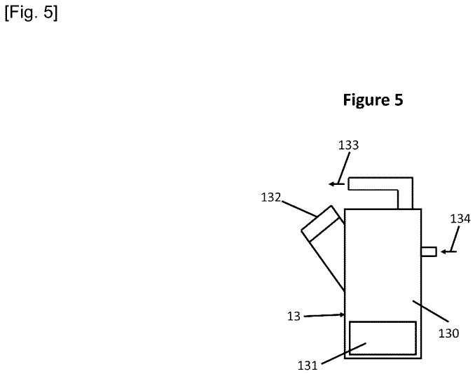

To this end, the fluid circulation circuit 9 comprises, between the electrolyzer 10 and the inlet 41 of the station 4 for converting urine into dihydrogen, a branch 12 on which is disposed an ultrasound generator 13, said branch 12 having a point 121 of origin on said circuit 9. Thus, between the electrolyzer 10 and the inlet 41 of the station 4 for converting urine into dihydrogen, the fluid circulation circuit 9 is divided into two legs, one leading to the station 4 for converting urine into dihydrogen and the other emerging, via the ultrasound generator 13, into the open air. The detail of the ultrasound generator 13 is provided schematically in FIG. 5.

The ultrasound generator 13 comprises a chamber 130 and an apparatus 131 for ultrasound nebulization housed inside said chamber 130. Said chamber 130 is equipped at least with a forced fluid circulation device 132, with at least one outlet to the ambient air 133 and with at least one liquid inlet 134 in fluidic communication with the or at least one of the liquid outlets 101 of the electrolyzer 10 for supply of said chamber 130 with electrolyzed liquid urine. The nebulization apparatus 131 is configured to convert at least a part of the electrolyzed liquid urine from the electrolyzer 10 into a cloud of fine particles of mist type, and the forced fluid circulation device 132 is configured to guide movement of the mist produced in the direction of the or at least one of the outlets to the ambient air 133 of said chamber 130.

In the example shown, the fluid circulation circuit 9 comprises, at said point 121 of origin of the branch 12, a connecting member 14, such as a three-way valve or a T-shaped connector, configured to allow, in parallel, supply of the branch 12 and of the station 4 for converting urine into dihydrogen with liquid from the electrolyzer 10.

In the example shown, the forced fluid circulation device 132 is in the form of a fan. This forced fluid circulation device 132 is disposed in an outlet to the ambient air of the chamber so as to draw in said outside air and generate an air flow inside the chamber. This air flow drives the mist produced at the apparatus 131 for ultrasound nebulization disposed in the lower part of the chamber 130 of the ultrasound generator 13 in the direction of another outlet to the ambient air of the chamber, disposed in the upper part of the chamber, so as to allow dispersion of this mist into the atmosphere. Thus, the ultrasound generator 13 makes it possible to evacuate into the atmosphere virtually all of the electrolyzed urine from the electrolyzer 10 that is transferred into the ultrasound generator 13.

In order to perfect the installation, a non-return valve can be disposed on the outlet to the ambient air of the ultrasound generator.

In order to obtain effective nebulization, the amount of liquid to be introduced into the ultrasound generator 13 is controlled. Ideally, the electrolyzer 10 and the ultrasound generator 13 are dimensioned correspondingly, such that the maximum volume contained in the electrolyzer can be treated all at once by the ultrasound generator 13.

In order to perfect the installation and increase the quality of the liquid at the inlet 41 of the station 4 for converting urine into dihydrogen, the fluid circulation circuit 9 comprises, between the point 121 of origin of the branch 12 and the inlet 41 of the station 4 for converting urine into dihydrogen, at least one filtration device 15.

Likewise, the installation 1 comprises a cleaning product reservoir 16.

In practice, such an installation operates as follows: a user of the excrement treatment installation 1 takes up position at the collection station 2 or at a sanitary apparatus that can be connected to the collection station. Urine resulting from micturition and fecal matter resulting from defecation are collected in a dissociated manner. The urine disposed in the urine collecting part 2A of the collection station is brought by pumping or by gravitational flow into the buffer reservoir. From this buffer reservoir, a predetermined maximum amount of urine is brought by pumping or the like into the electrolyzer 10. The electrolytic treatment takes place. The electrolyzed urine is then evacuated from the electrolyzer 10. A part of this electrolyzed urine (around 80 to 90%) reaches the ultrasound generator 13 so as to be converted there into a mist expelled into the ambient air, while another part of this urine (10 to 20%) is brought to the station 4 for converting urine into dihydrogen. This dihydrogen produced is brought to the burner of the combustion chamber of the combustion station.

The fecal matter from the fecal matter collecting part 2B of the excrement collection station 2 and brought directly by gravity or by pumping into the combustion chamber is burned and converted into ash, collected in the ash tray of the combustion station 5. This ash tray can be emptied regularly.

1. An installation for treating excrement comprising urine and fecal matter, said treatment installation comprising:
a urine treatment unit and a fecal matter combustion station, the urine treatment unit comprising at least one station for converting urine into dihydrogen, the fecal matter combustion station comprising, housed inside a combustion chamber, at least one dihydrogen-powered burner and the treatment installation comprising at least one fluidic connection between the or at least one of the stations for converting urine into dihydrogen and the fecal matter combustion station so as to allow the burner to be supplied with dihydrogen from the dihydrogen produced at the station for converting urine into dihydrogen,
wherein the installation comprises an excrement collection station with a urine collecting part and a fecal matter collecting part that are separate, for dissociated collection of urine and fecal matter, in that the station for converting urine into dihydrogen has at least one liquid inlet and one outlet for gaseous fluid in the form of dihydrogen, in that the urine collecting part of the excrement collection station is connected to the or one of the inlets of the station for converting urine into dihydrogen by a fluid circulation circuit, and in that the fecal matter collecting part of the excrement collection station and the combustion chamber of the fecal matter combustion station that comprises a fecal matter supply inlet are connected to one another without passing through the urine treatment unit.

2. The excrement treatment installation as claimed in claim 1, wherein the fluid circulation circuit connecting the urine collecting part of the excrement collection station to the or one of the inlets of the station for converting urine into dihydrogen comprises at least one electrolyzer disposed on said circuit, this electrolyzer comprising at least one liquid inlet connected to the urine collecting part of the collection station and at least one liquid outlet connected at least by said fluid circulation circuit to the or an inlet of the station for converting urine into dihydrogen.

3. The excrement treatment installation as claimed in claim 2, wherein the fluid circulation circuit comprises, between the urine collecting part of the excrement collection station and the liquid inlet of the electrolyzer, a reservoir with a buffer reservoir function for allowing operation referred to as “batch” operation of the electrolyzer.

4. The excrement treatment installation as claimed in claim 2, wherein the fluid circulation circuit comprises, between the electrolyzer and the inlet of the station for converting urine into dihydrogen, a branch on which is disposed an ultrasound generator, the point at which the circuit divides to form said branch being called point of origin of said branch.

5. The excrement treatment installation as claimed in claim 4, wherein the ultrasound generator comprises a chamber and an apparatus for ultrasound nebulization housed inside said chamber, in that said chamber is equipped at least with a forced fluid circulation device, with at least one outlet to the ambient air and with at least one liquid inlet in fluidic communication with the or at least one of the liquid outlets of the electrolyzer for supply of said chamber with electrolyzed liquid urine, in that said nebulization apparatus is configured to convert at least a part of the electrolyzed liquid urine from the electrolyzer into a cloud of fine particles of mist type, and in that the forced fluid circulation device is configured to guide movement of the mist produced in the direction of the or at least one of the outlets to the ambient air of said chamber.

6. The excrement treatment installation as claimed in claim 4, wherein the fluid circulation circuit comprises, at said point of origin of the branch, a connecting member, such as a three-way valve or a T-shaped connector, configured to allow, in parallel, supply of the branch and of the station for converting urine into dihydrogen with liquid from the electrolyzer.

7. The excrement treatment installation as claimed in claim 4, wherein the fluid circulation circuit comprises, between the point of origin of the branch and the inlet of the station for converting urine into dihydrogen, at least one filtration device.

8. The excrement treatment installation as claimed in claim 1, wherein the combustion chamber of the fecal matter combustion station comprises at least one ash tray.

9. The excrement treatment installation as claimed in claim 1, wherein the installation comprises a cleaning product reservoir.

10. The excrement treatment installation as claimed in claim 1, wherein the station for converting urine into dihydrogen is an electrolyzer with a membrane.

11. A method for treating excrement comprising urine and fecal matter by means of an excrement treatment installation comprising at least one burner, the method comprising:
a urine treatment step comprising at least one operation of converting at least a part of the urine into dihydrogen and a step of combustion of fecal matter with the aid of the dihydrogen-powered burner supplied with dihydrogen at least from dihydrogen produced from at least a part of the urine, wherein, the excrement treatment installation is in accordance with claim 1 and comprising at least one urine treatment unit and one fecal matter combustion station, the urine treatment unit comprising at least one station for converting urine into dihydrogen, the fecal matter combustion station comprising, housed inside a combustion chamber, the dihydrogen-powered burner,
the method further comprises a step of dissociated collection of urine and fecal matter so as to supply urine to the station for converting urine into dihydrogen of the urine treatment unit and to supply fecal matter to the combustion chamber without passing through the urine treatment unit.
